(19) United States
(12) Patent Application Publication
(10) Pub. No.: US 2018/0321569 A1
(43) Pub. Date: Nov. 8, 2018

(54) CHIP SCALE OPTICAL SYSTEMS

(71) Applicant: The Charles Stark Draper Laboratory, Inc., Cambridge, MA (US)

(72) Inventors: Steven Spector, Lexington, MA (US); Robin Dawson, Waltham, MA (US); Benjamin Lane, Sherborn, MA (US); Michael G. Moebius, Cambridge, MA (US)

(73) Assignee: The Charles Stark Draper Laboratory, Inc., Cambridge, MA (US)

(21) Appl. No.: 15/969,931

(22) Filed: May 3, 2018

Related U.S. Application Data
(60) Provisional application No. 62/501,389, filed on May 4, 2017.

(51) Int. Cl. G02F 1/21; G02F 1/295; G02B 6/12; G02B 6/35; G02F 1/125

(52) U.S. Cl. CPC G02F 1/218; G02F 1/2955; G02F 1/125; G02B 6/3546; G02B 6/12011; G02B 6/12033

(57) ABSTRACT

An optical phased array including a wafer, optical waveguides, a root optical waveguide, the root optical waveguide being optically connected at one end to one optical waveguide, another end of the root optical waveguide constituting an optical port, optical couplers disposed in an array and located on the wafer, the optical waveguides optically connecting the optical couplers to the optical port via respective optical paths, one optical path per optical coupler, configurable optical delay lines; each configurable optical delay line being disposed in one respective optical path from the respective optical paths; the configurable optical delay lines being configured such that the optical couplers emit a non-planar phase front near field radiation pattern from light received from a light source coupled to the optical port.

### CROSS REFERENCE TO RELATED APPLICATIONS

This application claims priority to and benefit of U.S. Provisional Application No. 62/501,389, filed May 4, 2017, entitled CHIP SCALE OPTICAL SYSTEMS, which is incorporated by reference herein in its entirety for all purposes.

### BACKGROUND

This invention relates generally to optical phased arrays and, more particularly, to optical components including optical phased arrays.

Phased arrays of antennas are used in radar and other applications in which a direction of an incoming radio frequency (RF) signal needs to be ascertained or in which an RF signal needs to be transmitted in a particular direction. One or more receivers, transmitters or transceivers are electrically connected to an array of antennas via feed lines, such as waveguides or coaxial cables. Taking a transmitter case as an example, the transmitter(s) operate such that the phase of the signal at each antenna is separately controlled. Signals radiated by the various antennas constructively and destructively interfere with each other in the space in front of the antenna array. In directions where the signals constructively interfere, the signals are reinforced, whereas in directions where the signals destructively interfere, the signals are suppressed, thereby creating an effective radiation pattern of the entire array that favors a desired direction. The phases at the various antennas, and therefore the direction in which the signal propagates, can be changed very quickly, thereby enabling such a system to be electronically steered, for example to sweep over a range of directions.

According to the reciprocity theorem, a phased array of antennas can be used to receive signals preferentially from a desired direction. By electronically changing the phasing, a system can sweep over a range of directions to ascertain a direction from which a signal originates, i.e., a direction from which the signal's strength is maximum.

Sun, Watts, et al., describe a phased array of optical antennas. (See U.S. Pat. No. 8,988,754 and Sun, Watts, et al., “Large-scale nanophotonic phased array,” Nature, Vol. 493, pp. 195-199, Jan. 10, 2013, the entire contents of each of which are hereby incorporated by reference herein for all that it discloses and for all purposes.) Each optical antenna emits light of a specific amplitude and phase to form a desired far-field radiation pattern through interference of these emissions.

There are numbers of applications where optics is used for imaging, ranging from imagers to spectrophotometers to medical applications, such as two photon excitation microscopy and fluorescence microscopy. In many of those applications, the range of practical applications is hindered by the size of the optical system.

A common limitation in microscopy applications is the inability to image deep within tissue or turbid/strongly scattering media. Index variations lead to scattering and the distortion of phase fronts, which impact imaging mechanisms and reduce signal. This can limit the effectiveness of confocal microscopy, fluorescence microscopy, and two-photon microscopy or place limitations on the thickness of samples investigated with these techniques because all three rely on achieving a tightly focused beam spot at the focal point.

Phase conjugate imaging has emerged as a method to counteract the effects of scattering and distortion of phase fronts when focusing or imaging deep within a sample. See for example, Hillman, T. R., Yamauchi, T., Choi, W., Dasari, R. R., Feld, M. S., Park, Y., & Yaqoob, Z. (2013). Digital optical phase conjugation for delivering two-dimensional images through turbid media. Scientific Reports, 3, 1909, Jang, M., Yang, C., & Vellekoop, I. M. (2017). Optical Phase Conjugation with Less Than a Photon per Degree of Freedom. Physical Review Letters, 118(9), 93902, Vellekoop, I. M., Cui, M. & Yang, C., Digital optical phase conjugation of fluorescence in turbid tissue, Appl Phys Lett 101, 081108 (2012), the entire contents of each of which are hereby incorporated by reference herein for all that it discloses and for all purposes.

Digital optical phase conjugation (DOPC) (as described in Hillman et al. 2013 Scientific Reports) utilizes a spatial light modulator (SLM) to “pre-distort” the incident wave-front on the sample to counteract the distortion that will be introduced by propagation through the sample. As a result of this “pre-distortion” an intense, undistorted beam-spot can be formed at the focus deep inside strongly scattering media. Recent work (Jang et al. 2017 Phys. Rev. Letters) shows that this technique can still be applied effectively on a low photon budget. However, phase conjugate imaging often relies on free space optics, precise alignment, and requiring the use of an SLM greatly increases the cost of the equipment.

There is a need for reduced size optical system.

There is also a need for reduced size optical systems that do not require precise alignment or the use of an SLM for digital optical phase conjugation.

It is a further need to an optical system reduced to the size of the chip.

### BRIEF SUMMARY

Embodiments of optical system reduced to the size of the chip are disclosed herein below.

In one or more embodiments, the optical phased array of these teachings includes a wafer, a plurality of optical waveguides; the plurality of optical waveguides being one of implanted in the wafer or disposed on the wafer; a root optical waveguide, the root optical waveguide being one of implanted in the wafer or disposed on the wafer, the root optical waveguide being optically connected at one end to one optical waveguide from the plurality of optical waveguides, another end of the root optical waveguide constituting an optical port, a plurality of optical couplers disposed in an array and located on the wafer, the plurality of optical waveguides optically connecting the plurality of optical couplers to the optical port via respective optical paths, one optical path per optical coupler, and a plurality of configurable optical delay lines; each configurable optical delay line from the plurality of configurable optical delay lines being disposed in one respective optical path from the respective optical paths; the plurality of configurable optical delay lines being configured such that the plurality of optical couplers emit a non-planar phase front near field radiation pattern, the plurality of optical couplers receiving light from a light source coupled to the optical port.

In one instance, an optical component includes the optical phased array of these teachings wherein the nonplanar phase front near field radiation pattern is configured to bend light in a predetermined pattern.

In another instance, the optical component is a confocal microscope and includes the optical phased array of these teachings wherein the nonplanar phase front near field radiation pattern is a spherical phase front near field radiation pattern configured to focus light at a predetermined focal point.

For a better understanding of the present teachings, together with other and further objects thereof, reference is made to the accompanying drawings and detailed description and its scope will be pointed out in the appended claims.

### BRIEF DESCRIPTION OF THE DRAWINGS

FIG. 1a is a schematic diagram plan view of a phased array of optical couplers, arranged in an H-tree;

FIG. 1b is a 1-D version of the H-tree array which visually shows the flat phase-front leaving the array;

FIG. 1c shows phase shifts placed along the path of the H-tree, thereby tilting the phase-front, enabling steering;

FIG. 2 is a schematic perspective illustration of a portion of a substrate embodying the phased array of optical couplers of FIG. 1a;

FIG. 3A shows application of path delays in the H-Tree to produce a non-planar phase-front leaving the array;

FIG. 3B shows application of reconfigurable time delays in the H-Tree to produce a non-planar phase-front leaving the array;

FIG. 3C shows another embodiment application of reconfigurable time delays in the H-Tree to produce a non-planar phase-front leaving the array;

FIG. 4 is a schematic block diagram of a computer (controller) that provides the inputs to the reconfigurable optical time delays;

FIG. 5A is a schematic diagram plan view of a dynamically tunable (reconfigurable) optical delay line;

FIGS. 5B1, 5B2 are schematic diagrams of another embodiment of a dynamically tunable (reconfigurable) optical delay line;

FIG. 5C is a schematic diagram of yet another embodiment of a dynamically tunable (reconfigurable) optical delay line;

FIG. 6 shows microlenses disposed proximate to the optical couplers;

FIG. 7 shows the spherical phase front resulting in focusing in the near field light received from a light source;

FIGS. 8A-8E show components for separating incoming and outgoing light;

FIG. 9 shows separating incoming and outgoing light by use of a circulator in conjunction with a modulator;

FIG. 10 shows a spectrometer placed at the output of the system of these teachings;

FIG. 10a shows a detector placed at the output of the system of these teachings; and

FIGS. 11A, 11B show schematically the application of optical delay lines to improve image quality.

### DETAILED DESCRIPTION

The description is not to be taken in a limiting sense, but is made merely for the purpose of illustrating the general principles of these teachings, since the scope of these teachings is best defined by the appended claims.

The above illustrative and further embodiments are described below in conjunction with the following drawings, where specifically numbered components are described and will be appreciated to be thus described in all figures of the disclosure:

As used herein, the singular forms “a,” “an,” and “the” include the plural reference unless the context clearly dictates otherwise.

Embodiments of optical system reduced to the size of the chip are disclosed herein below.

In order to elucidate these teachings, two related systems are presented herein below.

Sun, Watts, et al., describe a phased array of optical antennas. (See U.S. Pat. No. 8,988,754 and Sun, Watts, et al., “Large-scale nanophotonic phased array,” Nature, Vol. 493, pp. 195-199, Jan. 10, 2013, the entire contents of each of which are hereby incorporated by reference herein for all that it discloses and for all purposes.) Each optical antenna emits light of a specific amplitude and phase to form a desired far-field radiation pattern through interference of these emissions.

### Zero Optical Path Difference Phased Array

In some instances, an H-tree that delivers light to a series of outputs on the chip has been disclosed (see, for example, US Patent application publication No. US 2016/0245895, the entire contents of each of which are hereby incorporated by reference herein for all that it discloses and for all purposes). In US Patent application publication No. US 2016/0245895, the H-tree design keeps all the paths equal and thus a flat phase-front emerges from the array. This flat phase-front is independent of wavelength and thus this device can operate with broadband light.

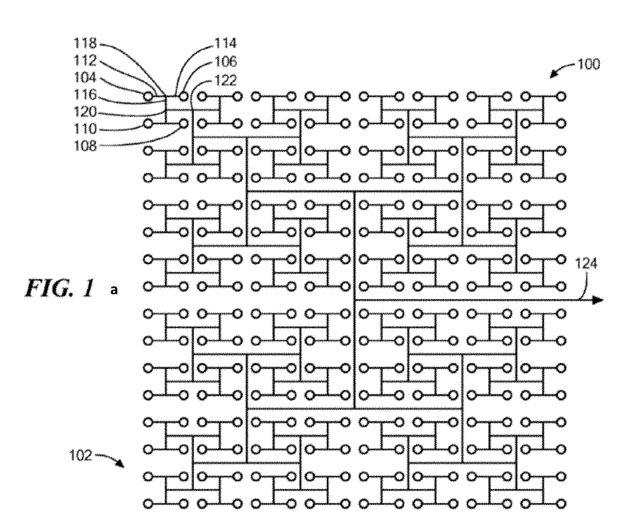

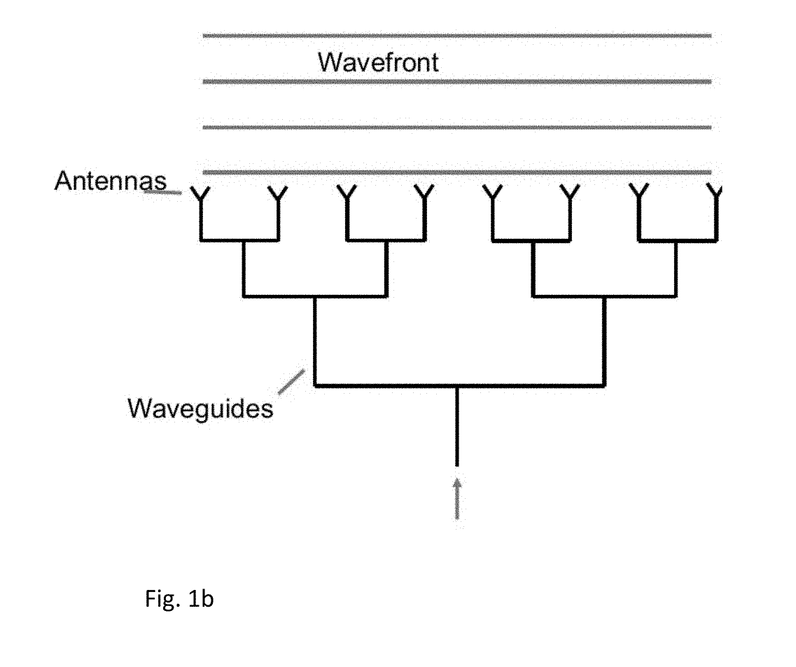

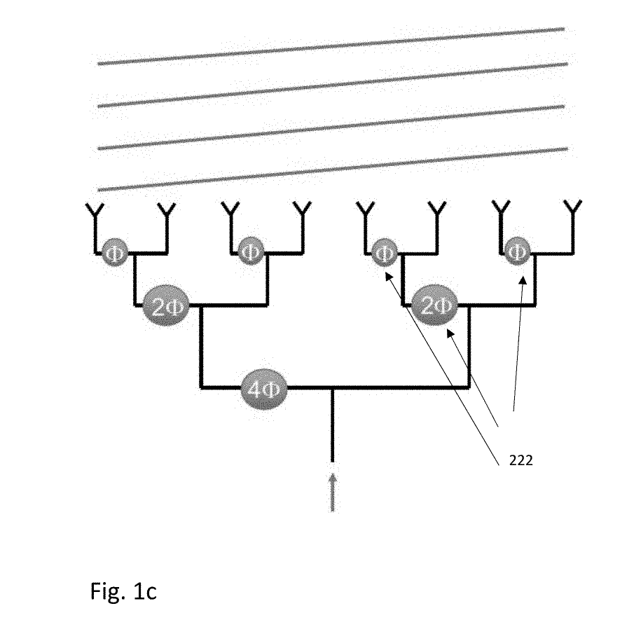

FIG. 1a is a schematic diagram plan view of a phased array 100 of optical couplers, represented by circles, arranged in an H-tree 102, according to an embodiment of the present invention. The optical couplers, exemplified by optical couplers 104, 106, 108 and 110, are connected to leaves of the H-tree 102. Lines in the H-tree, exemplified by lines 112, 114 and 116, represent optical waveguides or other optical feedlines. The optical waveguides 112-116 meet at optical splitters/combiners, represented by junctions 118, 120 and 122 of the lines 112-116. For example, the optical waveguides 112 and 114 connecting optical couplers 104 and 106 meet at an optical splitter/combiner 118. The entire phased array 100 is fed by an optical waveguide 124, which is referred to herein as a “root” of the H-tree.

In some embodiments, the phased array 100 is implemented on a photonic chip, such as a silicon wafer. “Wafer” means a manufactured substrate, such as a silicon wafer. The surface of the earth, for example, does not fall within the meaning of wafer. The photonic chip provides a substrate, and the photonic chip may be fabricated to provide the optical waveguides 112-116 within a thickness of the substrate. The optical waveguides 112-116 may be made of glass or another material that is optically transparent at wavelengths of interest. The optical waveguides 112-116 may be solid or they may be hollow, such as a hollow defined by a bore in the thickness of the substrate 200, and partially evacuated or filled with gas, such as air or dry nitrogen. The optical waveguides 112-116 may be defined by a difference between a refractive index of the optical medium of the waveguides and a refractive index of the substrate or other material surrounding the optical waveguides 112-116. The photonic chip may be fabricated using conventional semiconductor fabrication processes, such as the conventional CMOS process.

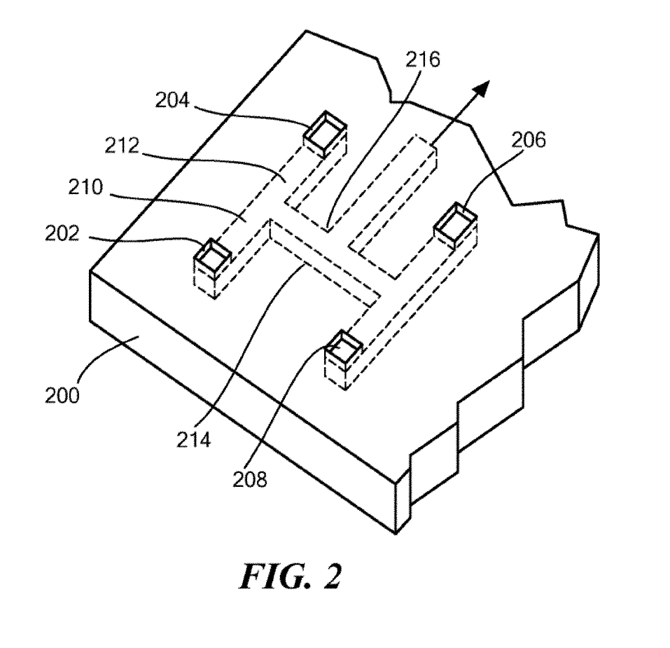

FIG. 2 is a schematic perspective illustration of a portion of such a substrate 200. FIG. 2 shows four optical couplers 202, 204, 206 and 208, which correspond to the optical couplers 104-108 in FIG. 1a. The optical couplers 104-108 are arranged in an array, relative to the substrate 200. In the embodiment shown in FIG. 2, the optical couplers 104-108 are coplanar. FIG. 2 also shows optical waveguides 210, 212 and 214, which correspond to the optical waveguides 112-116 in FIG. 1a. An optical combiner/splitter 216 in FIG. 2 corresponds to the optical combiner/splitter 120 in FIG. 1a.

In order to better illustrate the design described in US Patent application publication No. US 2016/0245895 (a similar approach also being useful in order to better illustrate these teachings), the −H-tree design is shown conceptually in FIG. 1b, for a one-dimensional array. For ease of understanding, concepts will continue to be described using a 1-D array examples, but can be implemented in 1-D or 2-D analogously.

As shown FIG. 1c phase shifters 222 are added to the H-tree. The phase shifters are used to impart a tilt to the phase-front, directing the beam emerging from the phased-array to a specific angle. (The phase shifters can also be used to correct for imperfections in the fabrication of the chip). By actively changing the phase shifts to impart different tilted phase-fronts, the beam can be steered. As shown in FIG. 1c, in the embodiment shown in US Patent application publication No. US 2016/0245895, a tilted phase-front is produced by a binary method where a phase shift with regular multiples (2̂n) of a particular phase shift is added at each branch of the tree to produce. In this embodiment, control can be simple, and if the phase shifts are implemented by means of a true time delay, the device maintains broadband operation. Other methods for implementing beam-steering in phase arrays are described (Hansen, R. C. (1998). Phased Array Antennas. New York, N.Y.: John Wiley & Sons.), and also applicable.

In previous systems, either far field patterns or a planar phase front (or both) have been of interest. In these teachings, a nonplanar phase front near field radiation pattern is obtained.

### Chip Scale Optical Systems

In one or more embodiments, the optical phased array of these teachings includes a wafer, a plurality of optical waveguides; the plurality of optical waveguides being one of implanted in the wafer or disposed on the wafer; a root optical waveguide, the root optical waveguide being one of implanted in the wafer or disposed on the wafer; the root optical waveguide being optically connected at one end to one optical waveguide from the plurality of optical waveguides, another end of the root optical waveguide constituting an optical port, a plurality of optical couplers disposed in an array and located on the wafer, the plurality of optical waveguides optically connecting the plurality of optical couplers to the optical port via respective optical paths, one optical path per optical coupler, and a plurality of configurable optical delay lines (also referred to as configurable phase shifters although the term phase shifters typically applies to narrow band applications); each configurable optical delay line from the plurality of configurable optical delay lines being disposed in one respective optical path from the respective optical paths; the plurality of configurable optical delay lines being configured such that the plurality of optical couplers emit a non-planar phase front near field radiation pattern, the plurality of optical couplers receiving light from a light source coupled to the optical port.

In one instance, an optical component includes the optical phased array of these teachings wherein the nonplanar phase front near field radiation pattern is configured to bend light in a predetermined pattern

In another instance, the optical component is a confocal microscope and includes the optical phased array of these teachings wherein the nonplanar phase front near field radiation pattern is a spherical phase front near field radiation pattern configured to focus light at a predetermined focal point.

Optical path length” (OPL), “optical distance” and “optical length” means a product (OPL=1n) of geometric length (1) of a path light follows through a medium and index of refraction (n) of the medium through which the light propagates. The index of refraction of a material is a measure of how much faster light propagates through a vacuum than it does through the material. The index of refraction (n=c/v) is determined by dividing the speed of light (c) in a vacuum by the speed of light (v) in the material.

As used herein, “optical coupler” means an optical antenna or other interface device between optical signals traveling in free space and optical signals traveling in a waveguide, such as an optical fiber or solid glass. In embodiments where optical waveguides extend perpendicular to a desired direction of free-space propagation, an optical coupler should facilitate this change of direction. Examples of optical couplers include compact gratings, prisms fabricated in waveguides and facets etched in wafers and used as mirrors. An “optical antenna” is a device designed to efficiently convert free-propagating optical radiation to localized energy, and vice versa. Optical antennas are described by Palash Bharadwaj, et al., “Optical Antennas,” Advances in Optics and Photonics 1.3 (2009), pp. 438-483, the entire contents of which are hereby incorporated by reference herein for all that it discloses and for all purposes.

“Configured to bend light,” as used herein, refers to configured to bend rays of light in the same manner as in an optical component (lens or reflective or diffractive equivalent).

True-time delay (TTD) is a property of a transmitting/receiving systems and refers to invariance of time delay with frequency, which is a delay without dispersion, or equivalently (due to properties of the Fourier transform) to linear phase progression with frequency. True-time delay, in practical situations, is defined over a frequency range (or equivalently a wavelength range).

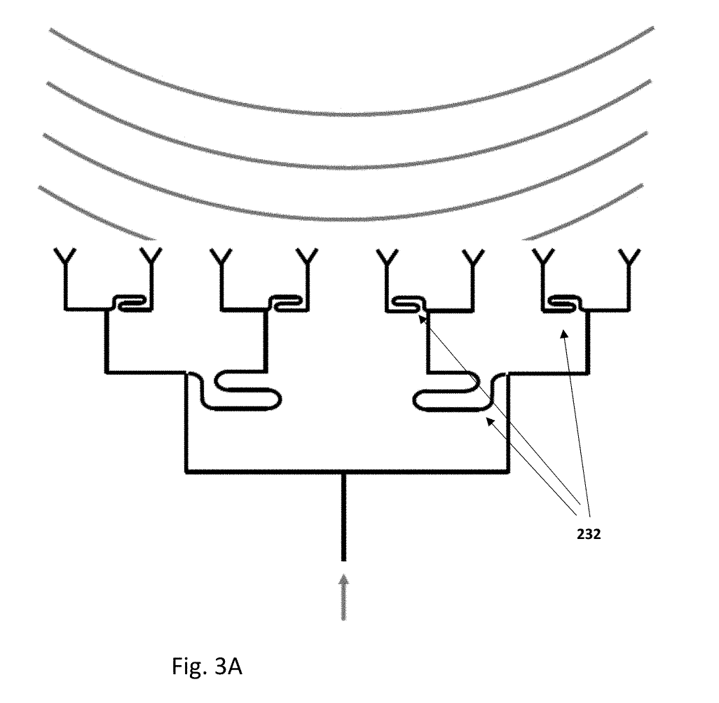

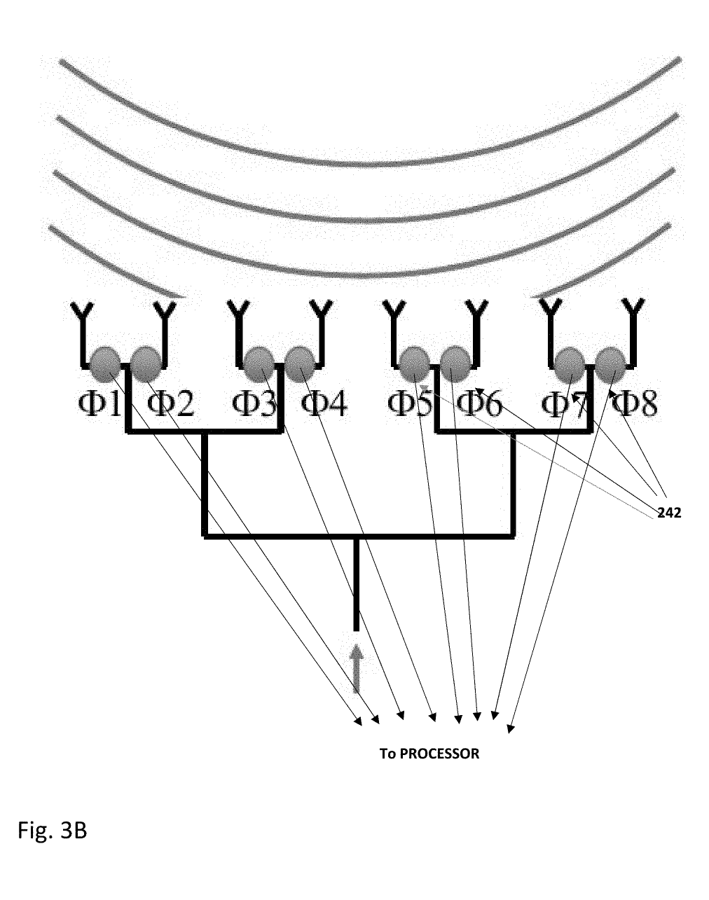

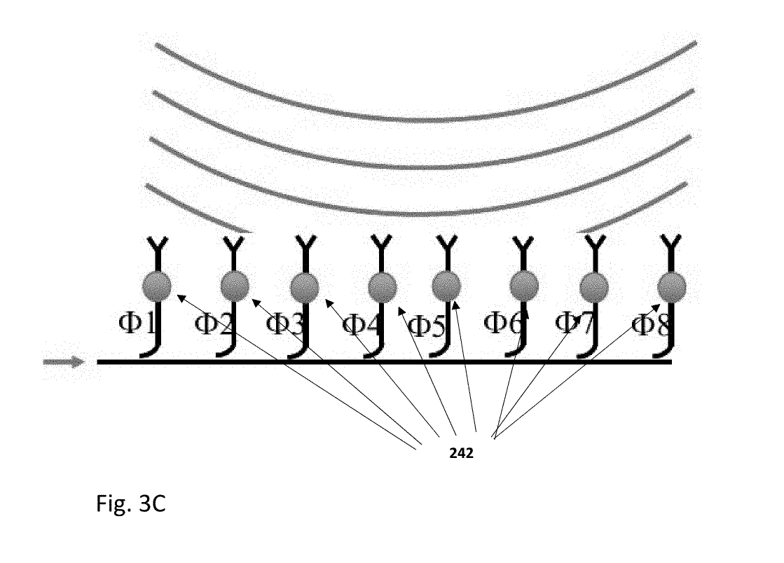

In order to implement optical components, a nonplanar near field phase front is needed. In one embodiment, shown in FIG. 3A, a nonplanar near field phase front is obtained by implementing configurable true time delays 232, true time delay component being disposed in one optical path connecting one coupler to the optical port, the true time delay component being optically and operatively connected to the optical waveguide in that optical path. If the time delays are implemented with minimal dispersion (or with dispersion compensation to achieve minimal dispersion) broadband operation is still maintained.

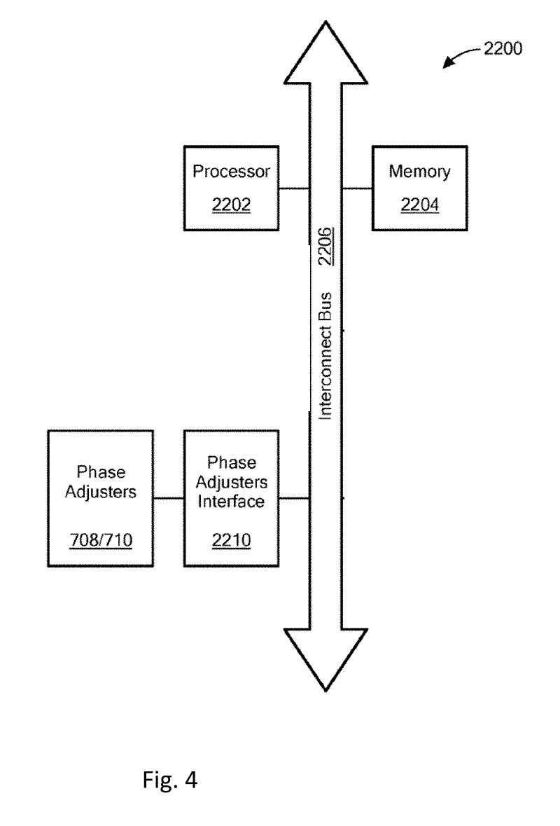

In the embodiments shown in FIGS. 3B and 3C, a reconfigurable optical delay line 242 (also referred to as a reconfigurable phase shifter although the term phase shifters typically applies to narrow band applications) is disposed in one optical path connecting one coupler to the optical port, the reconfigurable optical delay line being optically operatively connected to the optical waveguide in the optical path. Each reconfigurable optical delay line is operatively connected to a processor in a computer or controller. FIG. 4 is a schematic block diagram of a computer 2200 that provides the inputs to the reconfigurable optical delay lines 242. The computer 2200 includes a processor 2202 that executes instructions stored in a memory 2204. The processor 2202 may be a single-core or multi-core microprocessor, microcontroller or other suitable processor. The processor 2202 and memory 2204 may be interconnected by an interconnect bus 2206. The interconnect bus 2206 delivers instructions from the memory 2204 to the processor 22002, and the interconnect bus 2206 delivers data from the processor 2202 to be stored by the memory 2204. The interconnect bus 2206 also interconnects other components of the computer, as shown and described herein. The reconfigurable optical delay lines are operatively connected to a phase adjusters peripheral interface circuit 2210. The interface circuit 2210 may include suitable digital-to-analog converters (DACs), amplifiers, level converters, etc. for converting digital signals from the processor 2202 to voltages and/or currents suitable for the reconfigurable optical delay lines.

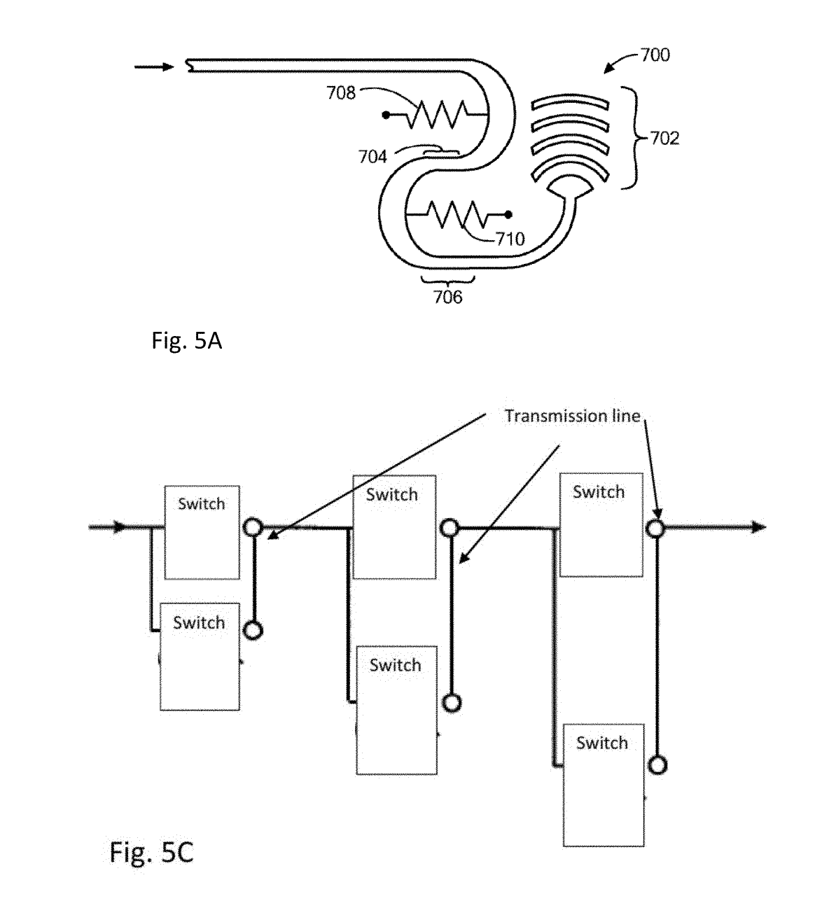

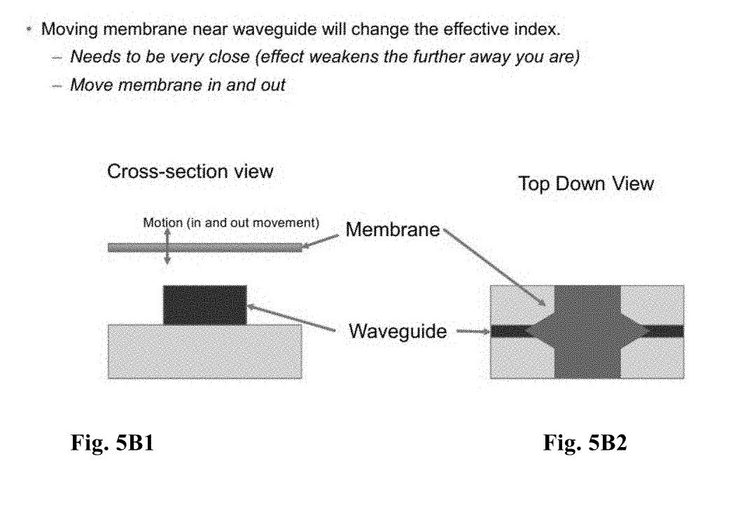

There are a number of embodiments of the reconfigurable optical delay lines (also referred to as reconfigurable phase shifters although the term phase shifters typically applies to narrow band applications). One embodiment is shown in FIG. 5A. FIG. 5A is a schematic diagram plan view of a dynamically tunable optical delay line 700 feeding a compact grating 702 optical coupler. Lengths of two sections 704 and 706 of the dynamically tunable optical delay line 700 may be temporarily adjusted by varying amounts of heat generated by two heaters 708 and 710 that are fabricated in the substrate 200. The amount of heat generated by each heater 708-710 may be controlled by a processor (not shown) executing instructions stored in a memory to perform processes that modify the phased array 100. Thus, each dynamically tunable optical delay line includes a thermally phase-tunable optical delay line. “Temporarily” mean not permanent. For example, after the heaters 708 and 710 cease generating heat, the two sections 704 and 706 of the dynamically tunable optical delay line 700 return to their respective earlier lengths, or at least nearly so.

Another embodiment is shown in FIGS. 5B1, 5B2. In this embodiment, a MEMS actuator, such as a cantilever, is located above one of the optical waveguides. Position of the actuator is designed such that, in the off state, the MEMS actuator does not affect the propagation properties of the optical waveguide seemed the interaction with the evanescent field is weak. By applying the actuating signal, typically a voltage, the cantilever (membrane) moves closer to the optical waveguide, close enough to interact with the evanescent field of the light in the waveguide, modifying the propagation properties. The MEMS actuator may be controlled by a processor (not shown) executing instructions stored in a memory to perform processes that modify the phased array 100.

In another embodiment, shown in FIG. 5C, the reconfigurable time delay is obtained by combining optical waveguides and optical switches. (See, for example, Elliott R. Brown, RF-MEMS Switches for Reconfigurable Integrated Circuits, IEEE TRANSACTIONS ON MICROWAVE THEORY AND TECHNIQUES, VOL. 46, NO. 11, NOVEMBER 1998, or Yihong Chen et al., Reconfigurable True-Time Delay for Wideband Phased-Array Antenna, Emerging Optoelectronic Applications, edited by Ghassan E. Jabbour, Juha T. Rantala, Proceedings of SPIE Vol. 5363 (SPIE, Bellingham, W A, 2004), both of which are incorporated by reference herein in their entirety and for all purposes.) The optical switches (labeled switch in FIG. 5C) may be controlled by a processor (not shown) executing instructions stored in a memory to perform processes that modify the phased array 100. It should be noted that an optical modulator acts as an optical switch and, for example, an acoustooptical modulator can be, in one embodiment, the optical switch. (See, for example, Pál Maák et al., Realization of True-Time Delay Lines Based on Acoustooptics, Journal of Lightwave Technology, VOL. 20, NO. 4, APRIL 2002, which is incorporated by reference herein in its entirety and for all purposes.)

Using the embodiments shown in FIGS. 3B and 3C, the phase shifts can be configured such that the optical couplers emit a nonplanar phase front near field radiation pattern when the optical couplers receiving light from a light source coupled to the optical port and also configured to tilt the phase front, thereby steering the emitted beam. A desired nonplanar phase front near field radiation pattern can be obtained by providing instructions to the processor. Because the spherical phase front is obtained by an arrangement of phase delays with stronger phase delays towards the center of the array of optical couplers, the phase shifts may be quite large, (many, many multiple wavelengths), and the phase shifts may need to be implemented modulo 2 pi. This may limit this particular implementation to narrowband light.

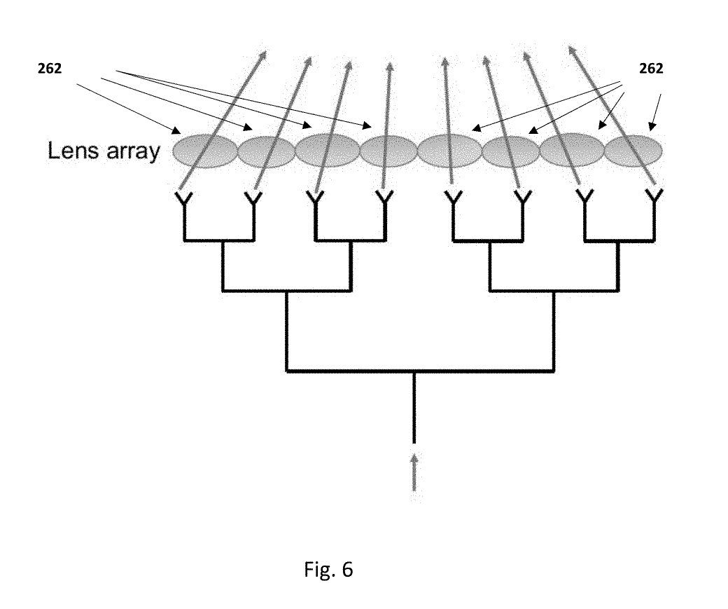

In one instance, shown in FIG. 6, microlenses 262 are disposed proximate to the optical couplers, one microlens disposed proximate to each optical coupler and optically disposed to receive the electromagnetic radiation being emitted by one optical coupler and to provide electromagnetic radiation to that optical coupler. In one instance, each microlens may be larger in diameter than the corresponding optical coupler, thereby capturing more light than the optical coupler would capture in the absence of the microlens. The microlens reduces the angular field of view the optical couplers would otherwise have and thereby eliminate or reduce grating lobes (side lobes) from the radiation pattern of the phased array. For spherical phase fronts, as in these teachings, the microlens are offset relative to the optical couplers. Since the microlenses are used for mainly selecting the diffraction order, and not significantly for focusing, exactness in the definition of the offset is not required. In one instance, the offset is such that a ray from a phase center of one optical coupler and perpendicular to the nonplanar phase front passes through a principal point of a thin lens equivalent of a microlens disposed proximate to that one optical coupler. Other definitions of the offset are within the scope of these teachings.

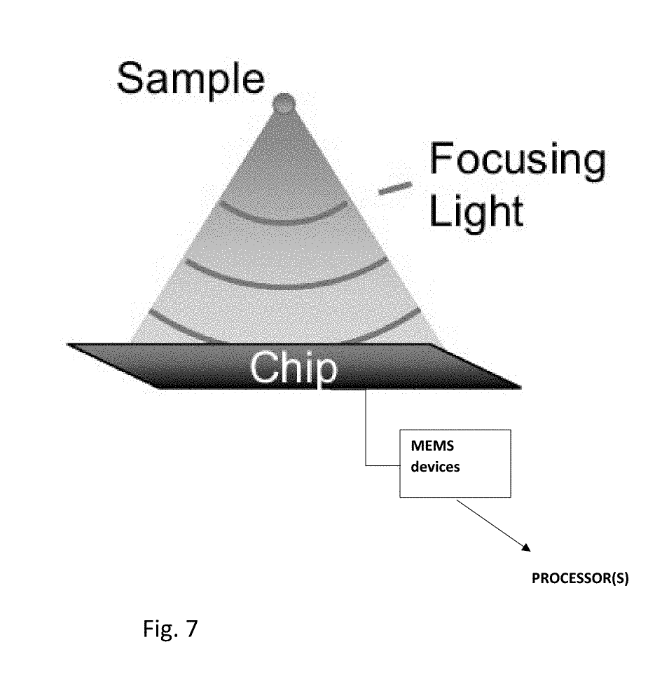

In one instance, the nonplanar phase front is a spherical phase front, as shown in FIG. 7. As shown in FIG. 7, the spherical phase front results in focusing in the near field light received from a light source coupled to the optical port. In one instance, the focus is diffraction limited by the numerical aperture, due to the wave nature of light. In one implementation, it should be noted that the spot can be scanned by means of MEMS devices that tilt the chip (the optical phase array disposed on the wafer). The MEMS devices are operatively connected to the wafer and can be controlled by commands generated by a processor (from a computer). Using both the scanning described hereinabove and the ability to change the nonplanar near field phase front, the optical phased array of these teachings can be operate in modes in which the spot is scanned in a horizontal plane, or in a vertical plane, or a 3D volume is scanned.

Herein above, the embodiment in which light received from a light source coupled to the optical port is emitted by the optical couplers resulting in a near field spherical phase front and is focused at a focal spot. Due to the reciprocity property of light, light emitted, scattered, or generated at the focal spot, would be collected by the optical phase array of these teachings and coupled to the same optical port. Thus the optical phased array of these teachings can be used a confocal microscope: light is focused to a spot by the microscope and only light from that spot is collected by the microscope.

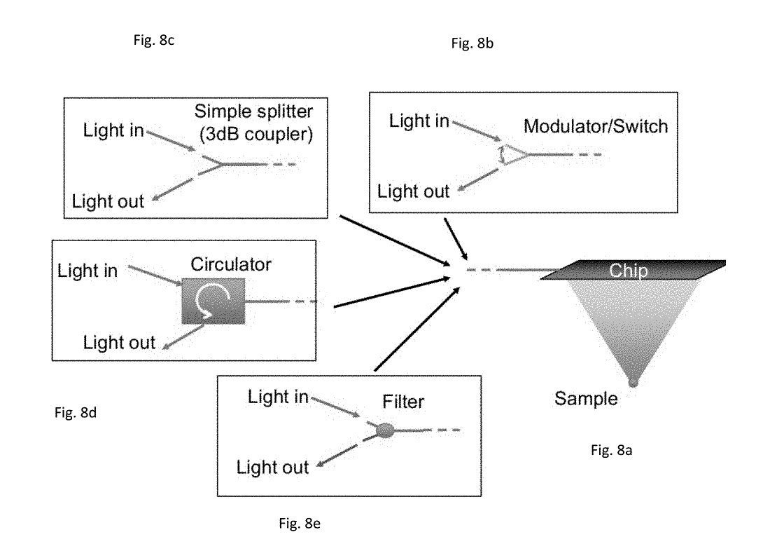

In the above described embodiments, the optical waveguides are connected to the optical port. In the embodiment in which light received from a light source coupled to the optical port is emitted by the optical couplers resulting in a near field spherical phase front and is focused at a focal spot, the optical port receives the incoming light and outputs the light collected by the optical phased array. A three port optical component in which one port is connected to the optical port of the optical phased array, another port receives the incoming light and a third port outputs the collected light can be used in many applications to separate the input light from the output light. FIGS. 8A-8E show a number of embodiments of the three port optical component. FIG. 8A shows an embodiment of the confocal microscope of these teachings including the optical port. In FIG. 8B, an optical switch separates the input light from the output light. An optical switch can operate by mechanical means, including MEMS components and PSU electric components, or can operate by acousto-optic effects (such as modulators), electro-optic effects, magneto-optic effects (which may require polarized light), or use liquid crystals (which may also require polarized light). Modulators are examples of optical switches. The optical switch can be, in one embodiment, an active switch. In the instance in which the incoming light is pulsed, an active switch can be activated to the output port from the time that the pulsed input light is off to the time of the next pulse.

In FIG. 8C, an optical splitter separates the input light from the output light. An optical splitter enables a signal on an optical port to be distributed among two or more other ports. In one instance, an optical splitter is formed by splitting an integrated waveguide into two other integrated waveguides.

In FIG. 8D, an optical circulator separates the input light from the output light. An optical circulator transfers light from a first port to a second port, and from the second port to a third optical port. (See, for example, U.S. Pat. No. 5,909,310, which is incorporated by reference herein in its entirety and for all purposes.)

In some instances, the output light, collected by the optical phased array, is of a wavelength or of a band of wavelengths different from the input light. In those instances, as shown in FIG. 8E, a filter can be used to separate the input light from the output light. In one embodiment, the filter is a configurable filter that can be configured to accept the band of wavelengths corresponding to either the input light on the output light. The filter can be mechanically actuated or actively changed.

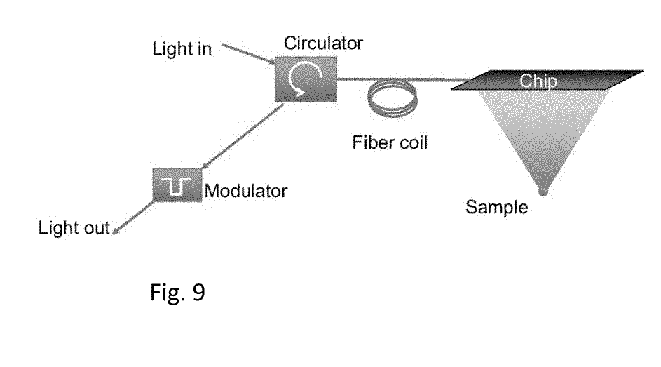

It should be noted that embodiments that combine several of the above described techniques for separating the input light from the output light are also within the scope of these teachings. FIG. 9 shows an embodiment in which a modulator is combined with a circulator.

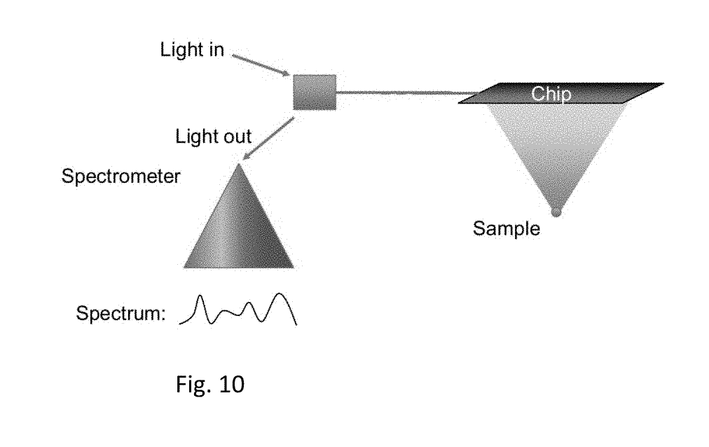

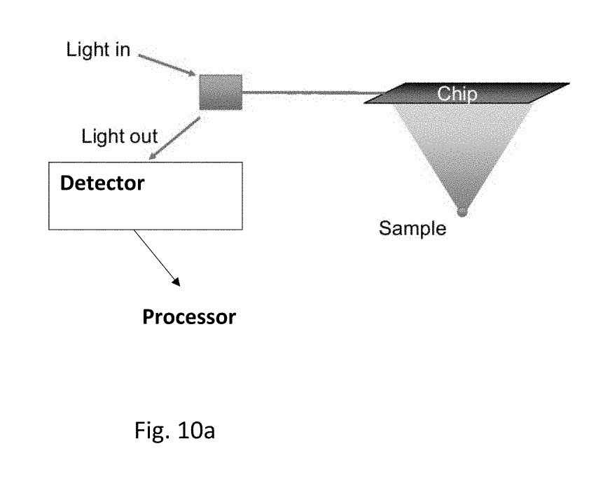

In many instances, additional components are used to analyze the output light from the confocal microscope of these teachings. In one exemplary embodiment, shown in FIG. 10, a spectrometer is used to analyze the output light. In another exemplary embodiment, shown in FIG. 10a, a detector is used to convert the output light into electrical signals which can be provided to a processor.

In digital optical phase conjugation (OPC), phase conjugation is performed by a sensor and an actuator (see Hillman, T. R., Yamauchi, T., Choi, W., Dasari, R. R., Feld, M. S., Park, Y., & Yaqoob, Z. (2013), Digital optical phase conjugation for delivering two-dimensional images through turbid media, Scientific Reports, 3, 1909). The actuator, in one instance, in conventional optics systems, is a spatial light modulator (SLM) that imparts a user controlled phase distribution to the light impinging on the SLM. A phased-array emitter/imager can be configured to fulfill the role of the actuator, such as the SLM, enabling a compact chip-scale phase conjugate imaging setup. The reconfigurable optical delay lines (also referred to as reconfigurable phase shifters) can be configured to impart a predetermined phase front distortion to counteract scattering that will occur as light emitted from the phased array enters the sample and/or compensate for distortion of signal emitted by the sample as it enters the phased array.

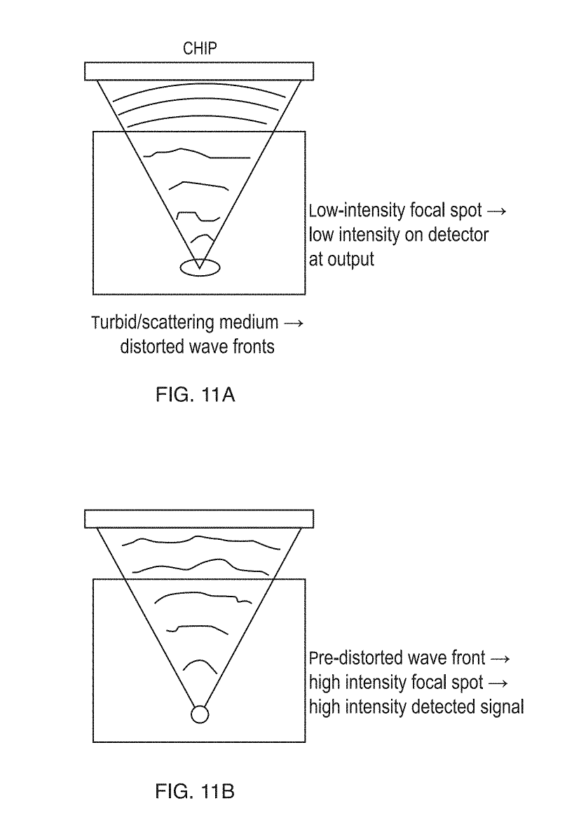

The sensor, in one instance, in conventional optics systems, is a pixelated detector such as a CCD or CMOS detector. The sensor is used to acquire the amplitude of the field distribution of the scattered light wave. Conventional phase conjugate imaging setups determine the phase front distortion imparted by the sample by using a reference beam to measure, using the sensor, the electric field phase and magnitude exiting the sample. The SLM is then configured based on this information. When light emitted, scattered, or generated at the focal spot, is collected by the optical phased array of these teachings and coupled to the same optical port. FIGS. 11A, 11B show schematically depicts the effects of phase front distortion on the focus formed inside of a turbid medium and the improvement of the focal spot achieved by pre-distorting the wave front using the reconfigurable delay lines. Total power collected at the output port of the chip can be used, by instructions to the processor in the computer, in order to determine the beam spot quality for one configuration of the reconfigurable optical delay lines. The total power collected will be maximized for a configuration that counteracts scattering. Comparing the total output power for multiple configurations of the reconfigurable optical delay lines, the computer can be configured to determine another configuration of the reconfigurable optical delay lines that results in a phase front that counteracts scattering. One item of interest is the enhancement ratio between an “un-corrected” and “corrected” beam sent into a scattering medium. This process can be iterated or used in order to determine a configuration of the reconfigurable optical delay lines that results in a phase front that forms a tightly focused spot at a given point within a strongly scattering medium.

Although the invention has been described with respect to various embodiments, it should be realized these teachings are also capable of a wide variety of further and other embodiments within the spirit and scope of the appended claims.

What is claimed is:

1. An optical phased array having a predetermined design wavelength and a predetermined design bandwidth, the optical phased array comprising:
a wafer;
a plurality of optical waveguides; the plurality of optical waveguides being one of implanted in the wafer or disposed on the wafer;
a root optical waveguide, the root optical waveguide being one of implanted in the wafer or disposed on the wafer; the root optical waveguide being optically connected at one end to one optical waveguide from the plurality of optical waveguides; another end of the root optical waveguide constituting an optical port;
a plurality of optical couplers disposed in an array and located on the wafer;
the plurality of optical waveguides optically connecting the plurality of optical couplers to the optical port via respective optical paths, one optical path per optical coupler; and
a plurality of configurable optical delay lines; each configurable optical delay line from the plurality of configurable optical delay lines being disposed in one respective optical path from the respective optical paths; the plurality of configurable optical delay lines being configured such that the plurality of optical couplers emit or receive a non-planar phase front near field radiation pattern; the plurality of optical couplers receiving light from one of a light source coupled to the optical port or propagating optical radiation impinging on at least some of the plurality of optical couplers.

2. A confocal microscope comprising:
the optical phased array of claim 1 wherein the nonplanar phase front near field radiation pattern is a spherical phase front near field radiation pattern configured to focus light at a predetermined focal point.

3. An optical component comprising:
the optical phased array of claim 1 wherein the nonplanar phase front near field radiation pattern is configured to bend light in a predetermined pattern.

4. The optical phased array of claim 1 further comprising a plurality of microlenses, each microlens of the plurality of microlenses being disposed proximate a respective optical coupler of the plurality of optical couplers; each microlens of the plurality of microlenses being offset relative to the respective optical coupler.

5. The optical phased array of claim 1 wherein at least some of the plurality of configurable optical delay lines comprise interaction with an evanescent field; said at least some of the plurality of configurable optical delay lines comprising a MEMS actuator configured to move a membrane close to a waveguide in order to interact with an evanescent field of light in the waveguide, modifying propagation properties.

6. The optical phased array of claim 1 wherein at least some of the plurality of configurable optical delay lines comprise a combination of optical waveguides and optical switches.

7. The optical phased array of claim 1 further comprising one or more processors operatively connected to the plurality of configurable optical delay lines; the one or more processors being configured to provide inputs to each reconfigurable optical delay line from the plurality of configurable optical delay lines such that the plurality of configurable optical delay lines is configured such that the optical couplers emit a predetermined nonplanar phase front near field radiation pattern when the optical couplers receiving light from a light source coupled to the optical port.

8. The optical phased array of claim 7 further comprising one or more MEMS devices operatively connected to the wafer; and wherein the one or more processors are also configured to provide inputs to the one or more MEMS devices were in the inputs are configured to tilt the phase front.

9. The optical phased array of claim 1 further comprising a three port optical component wherein a first port is operatively connected to the optical port and the second and third port being optically connected to the first port; the second report being configured to receive input light; the third port being configured to provide output light.

10. The optical phased array of claim 9 wherein the second and third port are optically connected to the first port by an optical splitter.

11. The optical phased array of claim 9 wherein the second and third port are optically connected to the first port by an optical switch.

12. The optical phased array of claim 11 wherein the optical switch comprises a modulator.

13. The optical phased array of claim 9 wherein the second and third port are optically connected to the first port by an optical circulator.

14. The optical phased array of claim 9 wherein the second and third port are optically connected to the first port by a configurable optical filter.

15. The optical phased array of claim 9 wherein the second and third port are optically connected to the first port by at least one of an optical splitter, an optical switch, a circulator and a configurable optical filter.

16. The optical phased array of claim 9 wherein the third port is optically connected to a spectrometer.

17. The optical phased array of claim 7 further comprising a three port optical component wherein a first port is operatively connected to the optical port and the second and third port being optically connected to the first port; the second report being configured to receive input light; the third port being configured to provide output light; wherein the third port is optically connected to a detector; and wherein an output on the detector is operatively connected to the processor.

18. The optical phased array of claim 17 wherein the processor is further configured to:
determine, from the output of the detector, beam spot quality for the light received by the plurality of optical couplers from a turbid scattering medium; and
determine the configuration of the plurality of the configurable optical delay lines that results in a phase front that counteracts scattering.

19. The optical phased array of claim 7 wherein the nonplanar phase front near field radiation pattern is configured to image light at a predetermined focal point when a light source is coupled to the optical port; and
wherein the processor is further configured to:
a) determine, from an output of a detector coupled to the optical port, beam spot quality for light received by the plurality of optical couplers from a field of view in turbid scattering medium; and
b) determine a configuration of the plurality of the configurable optical delay lines that results in a phase front that counteracts scattering.

20. The optical phased array of claim 19 wherein the processor is further configured to repeat steps (a) and (b) in order to obtain a larger total power collected.

21. A method for imaging light at a predetermined spot,
optically coupling a light source to an optical port in an optical phased array, the optical phased array comprising:
a plurality of optical waveguides;
a root optical waveguide optically connected at one end to one optical waveguide from the plurality of optical waveguides; another end of the root optical waveguide constituting the optical port;
a plurality of optical couplers disposed in an array; the plurality of optical waveguides optically connecting the plurality of optical couplers to the optical port via respective optical paths, one optical path per optical coupler; and
a plurality of configurable optical delay lines; each configurable optical delay line from the plurality of configurable optical delay lines being disposed in one respective optical path from the respective optical paths;
the plurality of configurable optical delay lines being configured such that the plurality of optical couplers emit a non-planar phase front near field radiation pattern; the non-planar phase front near field radiation pattern configured to focus emitted light onto the predetermined spot.

22. The method of claim 21 wherein the nonplanar phase front near field radiation pattern is a spherical phase front radiation pattern.

23. A method for receiving light from a predetermined spot, the method comprising:
receiving light at a plurality of optical couplers in an optical phased array, the optical phased array comprising:
a plurality of optical waveguides;
a root optical waveguide optically connected at one end to one optical waveguide from the plurality of optical waveguides; another end of the root optical waveguide constituting an optical port;
the plurality of optical couplers disposed in an array; the plurality of optical waveguides optically connecting the plurality of optical couplers to the optical port via respective optical paths, one optical path per optical coupler; and
a plurality of configurable optical delay lines; each configurable optical delay line from the plurality of configurable optical delay lines being disposed in one respective optical path from the respective optical paths;
the plurality of configurable optical delay lines being configured such that the plurality of optical couplers receive a non-planar phase front near field radiation pattern; the non-planar phase front near field radiation pattern configured to image light onto the predetermined spot when the optical couplers are receiving light from a light source coupled to the optical port.

24. The method of claim 23 wherein the nonplanar phase front near field radiation pattern is a spherical phase front radiation pattern.

25. The method of claim 23 wherein the predetermined spot is located in a turbid scattering medium; and wherein the method further comprises:
optically coupling the optical port to a detector;
a) determining, from an output of the detector coupled to the optical port, beam spot quality for light received by the plurality of optical couplers from a field of view in the turbid scattering medium; and
b) determining a configuration of the plurality of the configurable optical delay lines that results in a phase front that counteracts scattering.

26. The method of claim 25 further comprising repeating little steps (a) and (b) in order to obtain a larger total power collected.
